(19) United States
(12) Patent Application Publication
(10) Pub. No.: US 2012/0092301 A1
(43) Pub. Date: Apr. 19, 2012

(54) TOUCH SCREEN SYSTEM AND MANUFACTURING METHOD THEREOF

(75) Inventors: Jong Myoung Park, Gyeonggi-do (KR); Hoy Gun Kim, Seoul (KR); Yeon Jong Lee, Seoul (KR); Sang Hoon Han, Seoul (KR)

(73) Assignee: ACTS CO., LTD., Gyeonggi-do (KR)

(21) Appl. No.: 13/271,315

(22) Filed: Oct. 12, 2011

(30) Foreign Application Priority Data
Oct. 13, 2010 (KR) 10-2010-0100012

(51) Int. Cl. G06F 3/042; B23P 17/00

(52) U.S. Cl. 345/175; 29/527.1

(57) ABSTRACT

There is provided a touch screen system including: a sensor module including a light emitting unit configured to generate a light signal and a photo detection sensor configured to receive the light signal; a display panel including the sensor module; a front case including a reflection area configured to reflect the light signal generated from the light emitting unit to the photo detection sensor; and a back case connected to the front case with the display panel positioned therebetween. The front case is fixed and connected to the back case and the reflection area is placed at a predetermined position on the display panel.

### FIELD OF THE INVENTION

The present disclosure relates to a touch screen system and a manufacturing method thereof, and more specifically, to an optical touch screen system and a manufacturing method thereof.

### BACKGROUND OF THE INVENTION

Generally, a touch panel is one of various types of forming an interface between information and communication equipment using a display device and a user. The touch panel serves as an input device that enables a user to input desired information to the equipment by directly touching a screen with a finger or a touch pen.

There are two representative types of touch panels: a resistive type touch panel; and an infrared touch panel. A resistive type touch panel uses a conductive film and is configured such that chemicals are coated between a glass panel and a thin film and a thin metal plate is attached to side surfaces in X and Y-axes directions.

If electric power is supplied to such a panel, a certain resistance is generated. If a certain portion is touched with a finger or other objects such as a touch pen, the chemicals at the touched portion react to the touch and the resistance is changed immediately. Position coordinates of the portion touched with the object can be derived from this change in the resistance.

An infrared touch panel includes an infrared generating device configured to generate infrared lights in cross stripes on a display panel and a sensing device configured to sense the infrared lights generated from the infrared generating device.

In such an infrared touch panel, if a certain portion of the display panel is touched with a finger or other objects such as a touch pen, the infrared lights passing through the touched portion is interrupted and the sensing device such as an image sensor senses the interruption of the infrared lights. Thus, position information of the touched portion can be derived.

A user of this touch panel does not necessarily touch only a central portion of the touch panel, but also any portion of the touch panel. In order to increase accuracy of detecting a touched position on the whole area of the touch panel, a plurality of infrared generating devices is required. Accordingly, a plurality of infrared sensing devices is also required.

FIGS. 1a to 1c show configurations of conventional touch panels.

FIG. 1a shows a configuration of a touch panel in accordance with a conventional embodiment. This touch panel includes infrared light emitting diodes 11, 12, 13 and 14 provided at four edges of a rear surface of a frame.

Further, a series of photo detectors 21 are provided between the emitting diodes 11 and 12 and a series of photo detectors 22 are provide between the emitting diodes 13 and 14. The infrared light emitting diodes 11, 12, 13 and 14 are configured to radiate infrared lights.

By way of example, the infrared light emitting diodes 11, 12, 13 and 14 are configured to radiate infrared lights in a 2-dimensional fan shape and not to radiate the infrared lights toward unnecessary areas. The infrared lights generated from these infrared light emitting diodes can be radiated in contact with a screen.

Infrared lights are radiated from the emitting diodes one by one in order of, for example, the emitting diode 11, the emitting diode 12, the emitting diode 13 and the emitting diode 14. While each of the emitting diodes radiates infrared lights, a series of the photo detectors corresponding to each emitting diode detect photo detection signals.

That is, when the emitting diode 11 starts radiating infrared lights, photo detection signals are detected by the photo detectors 22 provided on the right in sequence from the top to the bottom. When the photo detector 22 positioned last at the bottom finishes the detection of signals, the emitting diode 11 finishes the radiation of the infrared lights.

Then, the photo detectors 22 provided on the right detect photo detection signals in sequence from the top to the bottom at the same time when the emitting diode 12 starts radiating infrared lights. When the photo detector 22 positioned last at the bottom finishes the detection of signals, the emitting diode 12 finishes the radiation of the infrared lights.

In the same manner, while the emitting diode 13 radiates infrared lights, the photo detectors 21 provided on the left detect photo detection signals and finally, while the emitting diode 14 radiates infrared lights, the photo detectors 21 detect photo detection signals.

FIG. 1b shows a configuration of a touch panel in accordance with another conventional embodiment in which a series of photo detector 23 provided between the emitting diodes 12 and 13 and a series of photo detectors 24 provided between the emitting diodes 11 and 14 are arranged in addition to the configuration of the touch panel depicted in FIG. 1a. That is, photo detectors are arranged in all of four edges of a quadrangular frame.

FIG. 1c shows a configuration of a touch panel in accordance with still another conventional embodiment in which two rod-shaped frames 31 and 32 are provided and an emitting diode is provided at each end of the respective rod-shaped frames 31 and 32 and also, a plurality of photo detectors are arranged between the emitting diodes.

The rod-shaped frames 31 and 32 including the emitting diodes and the photo detectors are arranged on a screen 40 so as to face each other.

However, the conventional touch panels depicted in FIGS. 1a to 1c have complicated configurations and require a lot of components. Therefore, such touch panels have low mass productivity and cannot be applied to all kinds of display devices.

Further, the complicated configuration and the increase in components result in an increase in costs and weight of the touch panel.

### BRIEF SUMMARY OF THE INVENTION

In order to solve the above-described problems of conventional techniques, the present disclosure provides a method of reducing the number of components of a touch panel system and simplifying a configuration thereof.

A purpose of the present disclosure is not limited to the above description and other purposes will be clearly understood from the descriptions below.

In order to achieve the above-described purpose, in accordance with an embodiment of the present disclosure, there is provided a touch screen system including: a sensor module including a light emitting unit configured to generate a light signal and a photo detection sensor configured to receive the light signal; a display panel including the sensor module; a front case including a reflection area configured to reflect the light signal generated from the light emitting unit to the photo detection sensor; and a back case connected to the front case with the display panel positioned therebetween. The front case may be fixed and connected to the back case and the reflection area is placed at a predetermined position on the display panel.

In order to achieve the above-described purpose, in accordance with another embodiment of the present disclosure, there is provided a front case of a touch screen system, the front case including: a reflection area configured to reflect a light signal generated from a light emitting unit of the touch screen system to a photo detection sensor. The front case may be connected to a back case of the touch screen system and the reflection area may be placed at a predetermined position on a display panel.

In order to achieve the above-described purpose, in accordance with an embodiment of the present disclosure, there is provided a touch screen system manufacturing method including: forming a reflection area including a reflection member inside a front case; and connecting the front case to a back case with a sensor module and a display panel positioned therebetween. The front case may be fixed and connected to the back case and the reflection area may be placed at a predetermined position on the display panel.

Further details to achieve the above-described purpose will be clearly understood by reference to the accompanying drawings and embodiments to be described below.

However, the present disclosure is not limited to the embodiments to be described below and various changes and modifications may be made. The embodiments will be provided to complete the present disclosure and provided for those skilled in the art to clearly understand the scope of the present disclosure.

In accordance with the foregoing descriptions, since a configuration of a touch panel system is simplified, the number of components to be used can be reduced, and, thus, manufacturing costs can be reduced.

Further, a weight of the touch panel system can be reduced, and, thus, a product can be light accordingly.

Furthermore, the touch panel system becomes easy to assemble, and, thus, it can be mass-produced and can be applied to all kinds of display devices.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIGS. 1A to 1C show configurations of conventional touch panels;

FIG. 2 shows a configuration of a touch panel system in accordance with an embodiment of the present disclosure;

FIG. 3 shows a rear surface of a front case 110 in accordance with an embodiment of the present disclosure; and

FIGS. 4A and 4B show reflection areas 111 in accordance with an embodiment of the present disclosure.

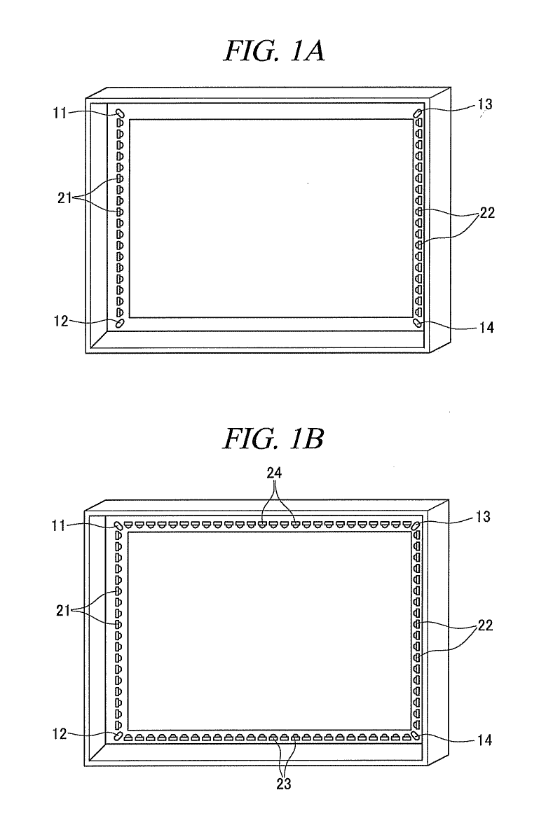

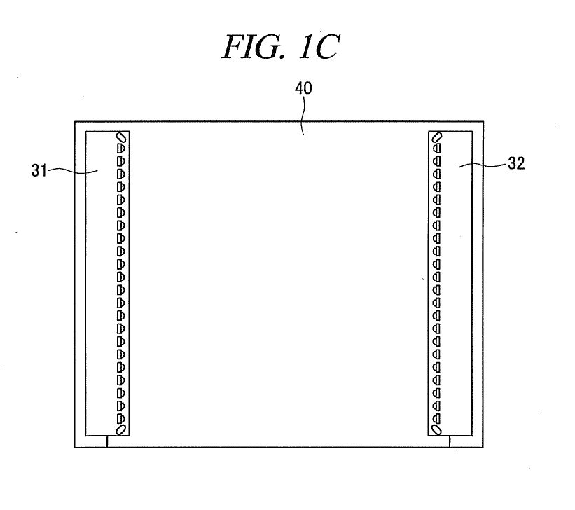

### DETAILED DESCRIPTION OF THE INVENTION

Hereinafter, embodiments of the present disclosure will be described in detail with reference to the accompanying drawings so that the present disclosure may be readily implemented by those skilled in the art.

However, it is to be noted that the present disclosure is not limited to the embodiments but can be realized in various other ways.

In the drawings, parts irrelevant to the description are omitted for clear explanation of the present disclosure, and like reference numerals denote like parts through the whole document.

Through the whole document, the terms “connected to” or “coupled to” that is used to designate a connection or coupling of one element to another element includes both a case that an element is “directly connected or coupled to” another element and a case that an element is “electronically connected or coupled to” another element via still another element.

Further, the terms “comprises or includes” and/or “comprising or including” used in the document means that one or more other components, steps, operation and/or existence or addition of elements are not excluded in addition to the described components, steps, operation and/or elements.

Hereinafter, by reference to the accompanying configuration views or process flowcharts, embodiments of the present disclosure will be explained in detail.

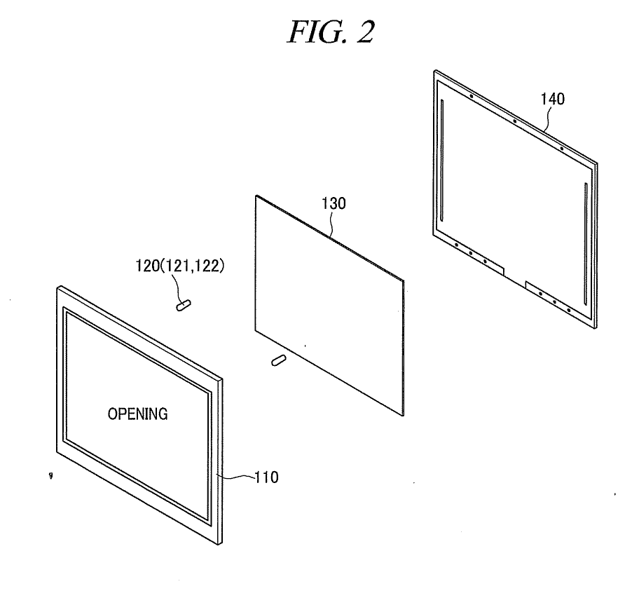

FIG. 2 shows a configuration of a touch panel system in accordance with an embodiment of the present disclosure.

A touch panel 100 may include a front case 110, a sensor module 120, a display panel 130, and a back case 140.

To be specific, the front case 110 may have a central opening and may be connected to the back case 140, so that a front surface of the display panel 130 can be overlaid with the front case 110.

Further, the front case 110 may include a reflection area 111 configured to retro-reflect infrared lights radiated from the sensor module 120 and the reflection area 111 can be integrated with the front case 110 in a mold structure.

By way of example, the reflection area 111 can be formed by extrusion molding when the front case 110 is formed.

Herein, the terms “retro-reflection” means reflecting light to its source. When a light signal generated from the sensor module as a light source reaches the reflection area 111, the light signal may be reflected back to the sensor module 120 as a light source by the reflection area 111.

In this case, if there are two sensor modules 120, it may be possible to detect incident angles of light signals interrupted by touch of the retro-reflected light signals. Based on a distance between the two incident angles and the sensor modules 120, it may be possible to calculate coordinates of a position touched on the screen by means of triangulation.

The front case 110 may be connected and fixed to the back case 140 to be described below, so that the reflection area 111 can be placed at a predetermined position on the display panel 130.

That is, the reflection area 111 can be placed at the predetermined position on the display panel 130 by fixed connection between the front case 110 and the back case 140 rather than chemical binding with an adhesive or the like.

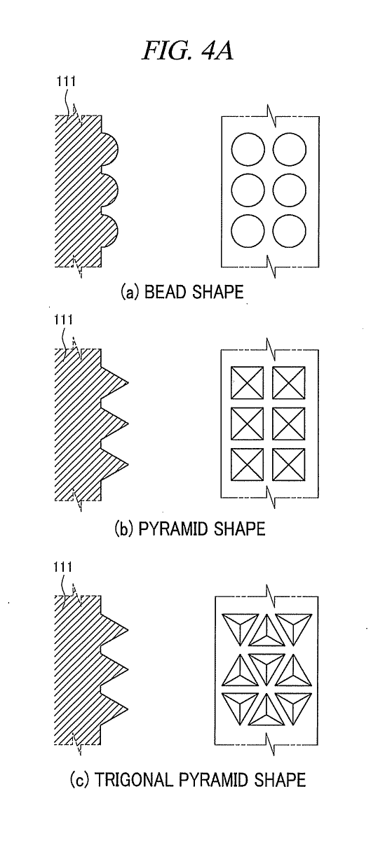

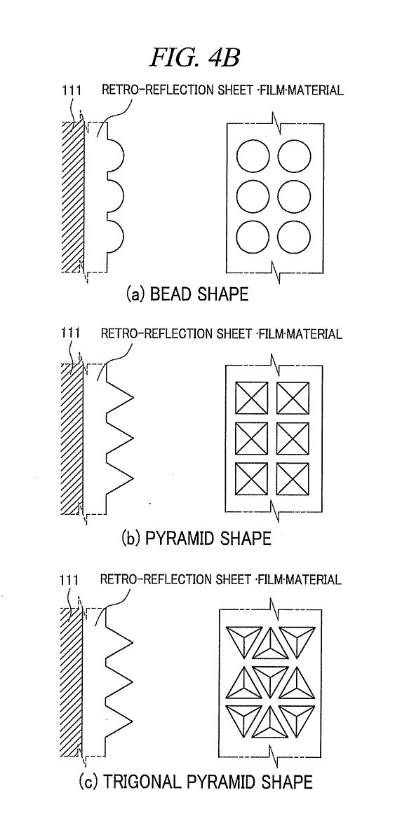

The front case 110 may have a height of about 3 mm or less, and the reflection area 111 will be explained later in detail by reference to FIGS. 4A and 4B.

The sensor module 120 may include a light emitting unit 121 and a photo detection sensor 122.

The light emitting unit 121 may generate a light signal and may include an infrared laser diode or an infrared LED which generates infrared lights so as not to be interfered by visible lights generated from the display panel 130.

The photo detection sensor 122 may receive a light signal generated from the light emitting unit 121 and retro-reflected by the reflection area 111.

If the received light signal is an infrared light, the photo detection sensor 122 may receive an infrared light in a predetermined range in order to suppress generation of noises and a wavelength in the predetermined range may be about 800 nm or more.

The light signal of the present disclosure may include, but is not limited to, an infrared light.

The sensor module 120 may be provided (fixed) to the display panel 130 to be described below.

The display panel 130 may include a display device such LCD, PDP and OLED and may further include a cathode-ray tube.

The display panel 130 may further include the above-described sensor module 120.

A protective panel (not shown) configured to protect the display panel 130 and made of a transparent material such as tempered glass may be provided closely to a surface of the display panel 130.

The back case 140 may form a set with the front case 110 to be connected to the front case 110 and may be provided closely to a rear surface of the touch panel 130.

That is, the back case 140 and the front case 110 may be fixed and connected to each other, so that the reflection area 111 can be placed at the predetermined position on the display panel 130 and a touch module including the touch panel 130, the sensor module 120 provided in the touch panel 130, and the reflection area 111 can be protected from external shock or the like.

Although not illustrated in FIG. 2, a position detector (not shown) configured to detect a position of a user's finger or other objects touching (inputting) on the display panel 130 may be further included in the touch panel 130.

When a light signal generated from the light emitting unit 121 of the module sensor 120 is retro-reflected from the reflection area 111 and returns to the photo detection sensor 122, the detector (not shown) may sense an object (finger or the like) touching the touch panel 130 and detect coordinates of a position of the sensed object by means of triangulation.

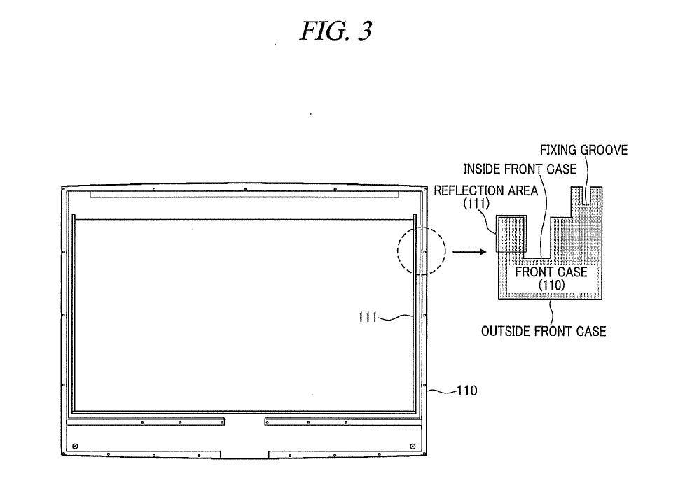

FIG. 3 shows a rear surface of the front case 110 and a cutting plane of the front case 110 in accordance with an embodiment of the present disclosure.

As depicted in FIG. 3, in the rear surface of the front case 110, the reflection area 111 for retro-reflection may be provided around the opening and the reflection area 111 may be integrated with the front case 110 in a mold structure.

Although it will be described later by reference to FIGS. 4A and 4B, the reflection area 111 may include reflection sections each formed in a bead shape, a pyramid shape, or a trigonal pyramid shape. Further, a retro-reflection sheet, a retro-reflection film or a retro-reflection material formed in a bead shape, a pyramid shape, or a trigonal pyramid shape may be attached to the reflection area 111.

As can be seen from a cross sectional view of a part of the front case 110, the reflection area 111 may exist in a fixing groove for connection to the back case 140.

As depicted in FIG. 3, the whole reflection area 111 may be formed in a quadrangular shape with one side open.

Hereinafter, the reflection area 111 will be explained in detail by reference to FIGS. 4A and 4B.

FIGS. 4A and 4B show the reflection areas 111 in accordance with an embodiment of the present disclosure.

As described above, the reflection area 111 may retro-reflect a light signal generated from the sensor module 120 and may be formed in a bead shape, a pyramid shape or a trigonal pyramid shape and integrated with the front case 110.

FIGS. 4A(a) to 4A(c) show each reflection area 111 integrated with the front case 110 and each reflection area 111 may include a penetration section where a light signal generated from the sensor module 120 penetrates and a retro-reflection section where the emitted light signal is retro-reflected.

The reflection area 111 may be formed in a bead shape, a pyramid shape or a trigonal pyramid shape on the front case 110 as depicted in FIGS. 4A(a) to 4A(c). Otherwise, a retro-reflection sheet, a retro-reflection film or a retro-reflection material formed in a bead shape, a pyramid shape, or a trigonal pyramid shape may be attached to the reflection area 111 as depicted in FIGS. 4B(a) to 4B(c).

As described above, in the touch panel system 100 in accordance with the present disclosure, the front case 110 and the reflection area 111 may be integrated with each other and the front case 110 may be fixed and connected to the back case 140, so that the reflection area 111 can be placed at the predetermined position on the display panel 130 without chemical binding with an adhesive or the like.

Therefore, its configuration can be simplified and the number of components to be used can be reduced, and, thus, manufacturing costs can be reduced.

Further, a weight of the touch panel system can be reduced, and, thus, a product can be light accordingly. Furthermore, the touch panel system may become easy to assemble, and, thus, it can be mass-produced and can be applied to all kinds of display devices.

The above description of the present disclosure is provided for the purpose of illustration, and it would be understood by those skilled in the art that various changes and modifications may be made without changing technical conception and essential features of the present disclosure.

Thus, it is clear that the above-described embodiments are illustrative in all aspects and do not limit the present disclosure.

For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF CODES

110: Front case
111: Reflection area
120: Sensor module
121: Light emitting unit
122: Photo detection sensor
130: Display panel
140: Back case.

What is claimed is:

1. A touch screen system comprising:
a sensor module including a light emitting unit configured to generate a light signal and a photo detection sensor configured to receive the light signal;
a display panel including the sensor module;
a front case including a reflection area configured to reflect the light signal generated from the light emitting unit to the photo detection sensor; and
a back case connected to the front case with the display panel positioned therebetween,
wherein the front case is fixed and connected to the back case and the reflection area is placed at a predetermined position on the display panel.

2. The touch screen system of claim 1,
wherein the reflection area includes a penetration section where the generated light signal penetrates and a retro-reflection section where the generated light signal is retro-reflected.

3. The touch screen system of claim 2,
wherein the retro-reflection section is formed in a bead shape, a pyramid shape, or a trigonal pyramid shape.

4. The touch screen system of claim 2,
wherein the retro-reflection section includes a retro-reflection sheet, a retro-reflection material or a retro-reflection film formed in a bead shape, a pyramid shape, or a trigonal pyramid shape.

5. The touch screen system of claim 1,
wherein the light signal includes an infrared light signal and the photo detection sensor receives an infrared light in a predetermined range.

6. The touch screen system of claim 5,
wherein a wavelength in the predetermined range is about 800 nm or more.

7. A front case of a touch screen system, the front case comprising:
a reflection area configured to reflect a light signal generated from a light emitting unit of the touch screen system to a photo detection sensor,
wherein the front case is connected to a back case of the touch screen system and the reflection area is placed at a predetermined position on a display panel.

8. The front case of claim 7,
wherein the reflection area includes a retro-reflection section formed in a bead shape, a pyramid shape, or a trigonal pyramid shape.

9. The front case of claim 7,
wherein the reflection area includes a retro-reflection sheet, a retro-reflection material or a retro-reflection film formed in a bead shape, a pyramid shape, or a trigonal pyramid shape.

10. A touch screen system manufacturing method comprising:
forming a reflection area including a reflection member inside a front case; and
connecting the front case to a back case with a sensor module and a display panel positioned therebetween,
wherein the front case is fixed and connected to the back case and the reflection area is placed at a predetermined position on the display panel.

11. The touch screen system manufacturing method of claim 10,
wherein the reflection area is formed by extrusion molding when the front case is formed.

12. The touch screen system manufacturing method of claim 10,
wherein the forming a reflection area including a reflection member inside a front case includes:
forming a retro-reflection section formed in a bead shape, a pyramid shape, or a trigonal pyramid shape.

13. The touch screen system manufacturing method of claim 10,
wherein the forming a reflection area including a reflection member inside a front case includes:
attaching a retro-reflection sheet, a retro-reflection material or a retro-reflection film formed in a bead shape, a pyramid shape, or a trigonal pyramid shape to the reflection area.
